(19) United States
(12) Patent Application Publication
(10) Pub. No.: US 2013/0258242 A1
(43) Pub. Date: Oct. 3, 2013

(54) LIQUID CRYSTAL DISPLAY DEVICE

(71) Applicant: JAPAN DISPLAY EAST INC., Mobara-shi (JP)

(72) Inventors: Hiroyuki SHIMOKAWA, Mobara (JP); Takuya KARUGOME, Kisarazu (JP)

(73) Assignee: Japan Display East Inc., Mobara-shi (JP)

(21) Appl. No.: 13/851,118

(22) Filed: Mar. 27, 2013

(30) Foreign Application Priority Data
Mar. 28, 2012 (JP) 2012-073530

(51) Int. Cl. G02F 1/1333

(52) U.S. Cl. CPC G02F 1/133305
USPC 349/61

(57) ABSTRACT

A flexible printed circuit board has a length extending in an arrangement direction of light emitting parts and a width extending in a direction orthogonal to the length. Each light emitting part includes electrodes on both end portions thereof respectively along the arrangement direction of the light emitting parts. The flexible printed circuit board includes a wiring pattern. The wiring pattern includes bonding portions where the light emitting part is bonded to the electrodes, and a wiring portion which is arranged between the light emitting parts arranged adjacent to each other. A fixing region portion of the wiring pattern which is positioned in a region where the bonding portion of the flexible printed circuit board is formed and a region displaced from the bonding portion in the width direction is larger than the wiring portion in the width direction.

### CROSS-REFERENCE TO RELATED APPLICATION

The present application claims priority from Japanese application JP 2012-073530 filed on Mar. 28, 2012, the content of which is hereby incorporated by reference into this application.

### BACKGROUND OF THE INVENTION

1. Field of the Invention

The present invention relates to a liquid crystal display device.

2. Description of the Related Art

A liquid crystal display device having a backlight includes light emitting parts. As such light emitting parts, light emitting diodes are used, and the light emitting parts are mounted on a flexible printed circuit board (JP 2010-62016 A). The light emitting parts are bonded to a wiring pattern of the flexible printed circuit board by solder welding.

Recently, there has been a demand for a backlight having a high bright performance and hence, a plurality of light emitting parts are arranged adjacent to each other. Further, it is often the case where double-sided wiring is used along with the increase of the number of light emitting parts and the increase of the parallel wiring for avoiding the elevation of an operational voltage to a high voltage caused by the increase of the number of light emitting parts. Due to these reasons, a flexible printed circuit board is difficult to be bent between the light emitting parts arranged adjacent to each other. Accordingly, when a bending stress is generated in the flexible printed circuit board, a stress generated in a bonding portion where the light emitting part is bonded by soldering is increased thus giving rise to a possibility that the light emitting part is peeled off.

It is an object of the present invention to provide a liquid crystal display device where a stress generated in a bonding portion between a light emitting part and a wiring pattern of a flexible printed circuit board can be reduced.

### SUMMARY OF THE INVENTION

(1) According to one aspect of the present invention, there is provided a liquid crystal display device including: a liquid crystal display panel; a plurality of light emitting parts which are arranged in at least one row; and a flexible printed circuit board on which the plurality of light emitting parts are mounted, the flexible printed circuit board having a length extending in an arrangement direction of the plurality of light emitting parts and a width extending in a direction orthogonal to the length; wherein each light emitting part includes electrodes on both end portions thereof along the arrangement direction of the plurality of light emitting parts in at least one row, the flexible printed circuit board includes a wiring pattern which is electrically connected to the electrodes of each light emitting part, the wiring pattern includes bonding portions where the light emitting part is bonded to the electrodes, and a wiring portion which is continuously formed in a length direction in a first region which includes a region formed between the light emitting parts arranged adjacent to each other and between the bonding portions arranged adjacent to each other, and a region displaced from the region in a width direction, a fixing region portion of the wiring pattern which is positioned in a second region including a region where the bonding portion of the flexible printed circuit board is formed and a region displaced from the bonding portion in the width direction is larger than the wiring portion in the width direction. According to the present invention, the fixing region portion is larger than the wiring portion in the width direction. Accordingly, at the bonding portions where the light emitting part is bonded to the electrodes, a bending resistance of the wiring pattern is large, while a bending resistance of the wiring pattern is relatively small at a portion between the light emitting parts arranged adjacent to each other. Due to such a constitution, the flexible printed circuit board is difficult to be bent in the region where the bonding portion is formed and hence, it is possible to reduce a stress generated in the bonding portion.

(2) In the liquid crystal display device described in (1), the flexible printed circuit board may be a laminated substrate and the wiring pattern may be constituted of a plurality of wiring layers, at least one of wiring layers may include the fixing region portion, at least one of wiring layers may include the wiring portion, and a total length of the fixing region portion of at least one of wiring layers in the width direction may be larger than a total length of the wiring portion of at least one of wiring layers in the width direction.

(3) In the liquid crystal display device described in (1) or (2), the wiring pattern may include an overlapping portion which overlaps with each light emitting part, and the overlapping portion may have a larger area than the wiring portion.

(4) In the liquid crystal display device described in (2), the wiring pattern may include an overlapping portion which overlaps with each light emitting part, the overlapping portion may have a larger area than the wiring portion, at least one of wiring layers may include the overlapping portion, at least one of wiring layers may include the wiring portion, and a total area of the overlapping portion of at least one of wiring layers may be larger than a total area of the wiring portion of at least one of wiring layers.

(5) In the liquid crystal display device described in any one of (1) to (4), each electrode of the light emitting part may be bonded to the bonding portion by soldering.

(6) In the liquid crystal display device described in any one of (1) to (5), the flexible printed circuit board may have a cutout portion at a position displaced from the wiring portion in the width direction.

(7) In the liquid crystal display device described in any one of (1) to (5), the flexible printed circuit board may include a plurality of insulation films laminated to each other, and at least one of insulation films may have a cutout portion at a position displaced from the wiring portion in the width direction.

(8) In the liquid crystal display device described in (7), at least one of insulation films other than at least one of insulation films which has the cutout portion may be cut in the width direction.

### BRIEF DESCRIPTION OF THE DRAWINGS

FIG. 1 is an exploded schematic view showing main parts of a liquid crystal display device according to an embodiment of the present invention;

FIG. 2 is a side view of a backlight;

FIG. 3 is a plan view which shows the detail of a flexible printed circuit board on which light emitting parts are mounted;

FIG. 4 is an exploded view of the flexible printed circuit board on which the light emitting parts are mounted;

FIG. 5 is a plan view showing the flexible printed circuit board;

FIG. 6 is a view for explaining an advantageous effect of the flexible printed circuit board of the embodiment;

FIG. 7 is a view for explaining a modification 1 of the flexible printed circuit board; and

FIG. 8 is a view for explaining a modification 2 of the flexible printed circuit board.

### DETAILED DESCRIPTION OF THE INVENTION

An embodiment of the present invention is explained hereinafter in conjunction with drawings.

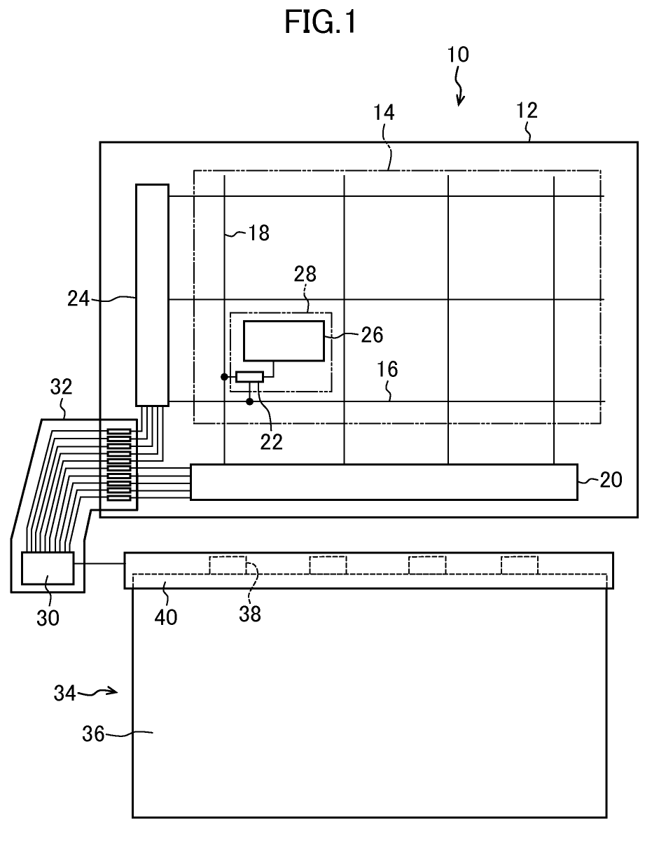

FIG. 1 is an exploded schematic view showing main parts of a liquid crystal display device according to the embodiment of the present invention. The liquid crystal display device includes a liquid crystal display panel 10. The liquid crystal display panel 10 includes a color filter substrate not shown in the drawing and a TFT (Thin Film Transistor) substrate 12, and a liquid crystal material not shown in the drawing is arranged between these substrates. The color filter substrate and the TFT substrate 12 are formed of a glass substrate, for example.

Video lines 16 and scanning lines 18 extend in an image display region 14. By controlling a switching element 22 (a thin film transistor, for example) in response to a scanning signal inputted to the scanning line 18 from a scanning circuit 20, a video signal inputted to the video line 16 from a hold circuit 24 is inputted to a pixel electrode 26. The liquid crystal material is driven based on a voltage applied between the pixel electrode 26 and a common electrode 28. An FPC (Flexible Printed Circuit) 32 on which a controller 30 is mounted is connected to the liquid crystal display panel 10, and the controller 30 controls the hold circuit 24 and the scanning circuit 20.

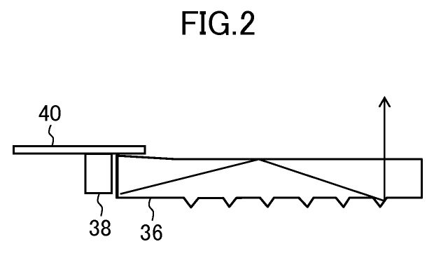

The liquid crystal display device includes a backlight 34. The backlight 34 includes a light guide plate 36. FIG. 2 is a side view of the backlight 34. To allow a light which advances in the inside of the light guide plate 36 to be reflected and advance toward a surface of the light guide plate 36, grooves or crests are formed on a back surface of the light guide plate 36. The surface of the light guide plate 36 faces a back surface of the liquid crystal display panel 10 in an opposed manner. The backlight 34 includes a plurality of light emitting parts 38. The light emitting part 38 is formed of a light emitting diode, for example. The light emitting part 38 forms a point light source for introducing a light into the inside of the light guide plate 36. The light emitted from the point light sources is converted into a surface light source by the light guide plate 36, and is irradiated to the liquid crystal display panel 10. The light emitting parts 38 face an end surface of the light guide plate 36 in an opposed manner. The plurality of light emitting parts 38 are mounted on a flexible printed circuit board 40. The flexible printed circuit board 40 is also electrically connected to the controller 30, and the light emitting parts 38 are controlled by the controller 30.

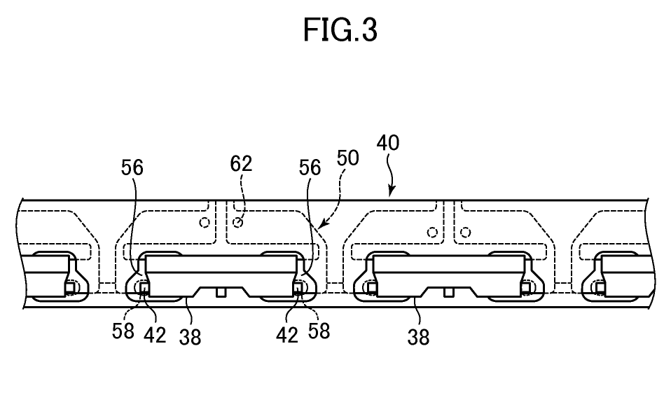

FIG. 3 is a plan view which shows the detail of the flexible printed circuit board 40 on which the light emitting parts 38 are mounted. The plurality of light emitting parts 38 are arranged in at least one row. The light emitting part 38 includes electrodes 42 which are mounted on both end portions thereof respectively along an arrangement direction of the light emitting parts 38 in at least one row. The flexible printed circuit board 40 has a length extending in the arrangement direction of the plurality of light emitting parts 38, and a width extending in the direction orthogonal to the length of the flexible printed circuit board 40.

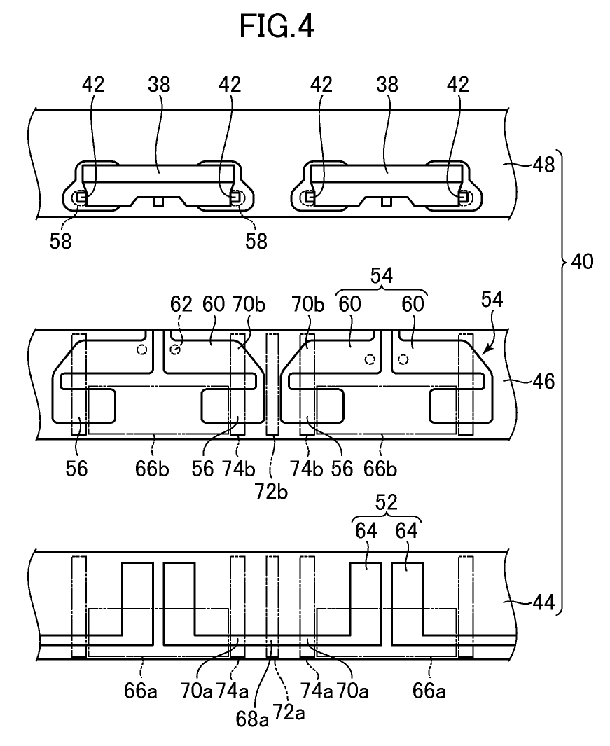

FIG. 4 is an exploded view of the flexible printed circuit board 40 on which the light emitting parts 38 are mounted. The flexible printed circuit board 40 is a laminated substrate. The flexible printed circuit board 40 includes a plurality of insulation films 44, 46, 48 laminated to each other. As shown in FIG. 3, the flexible printed circuit board 40 includes a wiring pattern 50. As shown in FIG. 4, the wiring pattern 50 is constituted of a plurality of wiring layers 52, 54. To be more specific, the wiring layers 52 are formed on the insulation film 44 which constitutes a lowermost layer, while the wiring layers 54 are formed on the insulation film 46 which constitutes an intermediate layer. The insulation film 48 which constitutes an uppermost layer functions as a protective film for the wiring pattern 50 (wiring layer 54), and has openings through which portions of the wiring layers 54 are exposed. The insulation film 46 which constitutes the intermediate layer supports the wiring layers 54 thereon, and also functions as a protective film for the wiring layers 52 arranged below the insulation film 46. In this embodiment, the plurality of wiring layers 52, 54 are formed so as to have the same thickness respectively.

The wiring pattern 50 is electrically connected to the electrodes 42 of the respective light emitting parts 38. The wiring pattern 50 (wiring layer 54) includes bonding portions 56 bonded to the electrodes 42 of the light emitting parts 38. The electrodes 42 of the light emitting parts 38 are bonded to the bonding portions 56 by soldering 58. The wiring layers 54 are formed in a separated manner from each other for every pattern where each wiring layer 54 includes one bonding portion 56. That is, the wiring layer 54 is constituted of a plurality of divided patterns 60 each of which includes the bonding portion 56.

The wiring layer 54 is electrically connected to the wiring layer 52 via a through hole 62 formed in the insulation film 46 which constitutes the intermediate layer. The wiring layer 52 is formed of a plurality of divided patterns 64. Each divided pattern 64 is connected to a pair of divided patterns 60 which, in turn, are connected to a pair of electrodes 42 which the light emitting parts 38 arranged adjacent to each other have and are arranged adjacent to each other. That is, the divided pattern 64 electrically connects the divided patterns 60 arranged adjacent to each other. Due to such a constitution, the wiring layers 52, 54 connect the plurality of light emitting parts 38 in series.

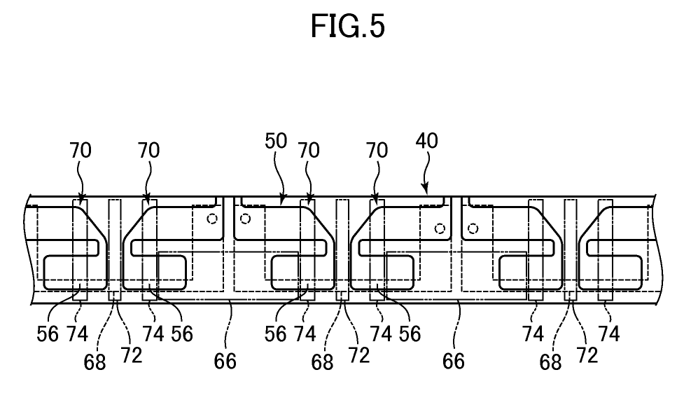

FIG. 5 is a plan view showing the flexible printed circuit board. The wiring pattern 50 includes an overlapping portion 66 which overlaps with each light emitting part 38. At least either one of the wiring layer 52 and the wiring layer 54 includes the overlapping portion 66. As shown in FIG. 4, the wiring layer 52 includes an overlapping portion 66a, and the wiring layer 54 includes an overlapping portion 66b.

As shown in FIG. 5, the wiring pattern 50 includes a wiring portion 68 which is arranged between the light emitting parts 38 arranged adjacent to each other and between the bonding portions 56 arranged adjacent to each other. The wiring portion 68 is continuously formed in a first region 72 in the length direction of the flexible printed circuit board 40. The first region 72 includes a region which is formed between the light emitting parts 38 (or the overlapping portions 66) arranged adjacent to each other and between the bonding portions 56 arranged adjacent to each other and a region displaced from the above region in the width direction of the flexible printed circuit board 40. The wiring portion 68 is not interrupted in the length direction of the flexible printed circuit board 40. At least either one of the wiring layer 52 and the wiring layer 54 includes the wiring portion 68. As shown in

FIG. 4, a first region 72a is formed on the insulation film 44, and a first region 72b is formed on the insulation film 46. While the wiring layer 52 has a wiring portion 68a in the first region 72a of the insulation film 44, a wiring portion is not present in the first region 72b of the insulation film 46. A portion of the wiring layer 54 arranged between the bonding portions 56 and the first region 72b is not formed continuously but is interrupted in the first region 72b and hence, the portion does not constitute a wiring portion. However, depending on a pattern of the wiring layer 54, the wiring layer 54 may have a wiring portion.

As shown in FIG. 5, the wiring pattern 50 includes fixing region portions 70. The fixing region portion 70 is positioned in a second region 74. The second region 74 includes a region of the flexible printed circuit board 40 where the bonding portion 56 is formed and a region of the flexible printed circuit board 40 which is displaced from the bonding portion 56 in the width direction. At least either one of the wiring layer 52 and the wiring layer 54 includes the fixing region portions 70. As shown in FIG. 4, the insulation film 44 includes second regions 74a, and the insulation film 46 includes second regions 74b. The wiring layer 52 includes fixing region portions 70a in the second regions 74a, and the wiring layer 54 includes fixing region portions 70b in the second regions 74b.

The fixing region portion 70 is larger than the wiring portion 68 in the width direction of the flexible printed circuit board 40. When both of the wiring layers 52, 54 include the wing portion 68, a total length of the fixing region portion 70a of the wiring layer 52 in the width direction and the fixing region portion 70b of the wiring layer 54 in the width direction is larger than a total length of the wiring portion 68 of the wiring layer 52 and the wiring portion 68 of the wiring layer 54 in the width direction. Alternatively, a section modulus of the fixing region portion 70 is larger than a section modulus of the wiring portion 68 in a cross section orthogonal to the length direction of the flexible printed circuit board 40. That is, when the flexible printed circuit board 40 is bent such that an axis of the flexible printed circuit board 40 which extends in the length direction is deflected, the fixing region portion 70 is more difficult to be bent than the wiring portion 68. When a section modulus differs corresponding to a position of a cross section, the smallest section modulus of the fixing region portion 70 is larger than the smallest section modulus of the wiring portion 68.

An area of the overlapping portion 66 is larger than an area of the wiring portion 68. A total area of the overlapping portion 66a of the wiring layer 52 and the overlapping portion 66b of the wiring layer 54 is larger than a total area of the wiring portion 68 of the wiring layer 52.

According to this embodiment, the fixing region portion 70 is larger than the wiring portion 68 in the width direction of the flexible printed circuit board 40. Alternatively, the area of the overlapping portion 66 is larger than the area of the wiring portion 68. Accordingly, a bending resistance of the wiring pattern 50 is large at the bonding portion 56 where the light emitting part 38 is bonded to the wiring pattern 50, while the bending resistance of the wiring pattern 50 is relatively small at a portion between the light emitting parts 38 arranged adjacent to each other.

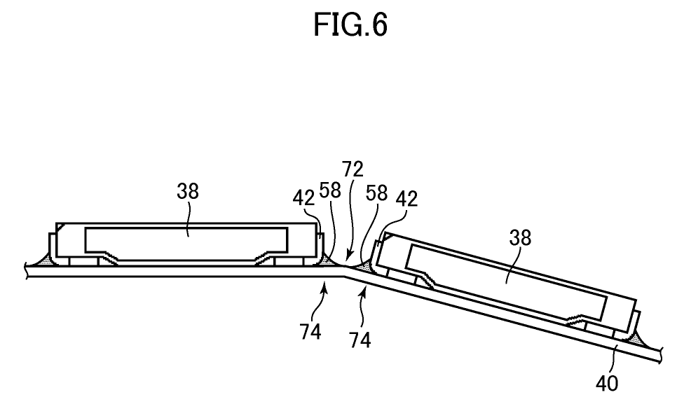

FIG. 6 is a view for explaining an advantageous effect acquired by the flexible printed circuit board of this embodiment. The flexible printed circuit board 40 is difficult to be bent in the region (second region 74) where the bonding portion 56 is formed by soldering 58 and hence, the flexible printed circuit board 40 is bent at a portion between the bonding portions 56 arranged adjacent to each other. Due to such a constitution, it is possible to reduce a stress generated in the bonding portion 56.

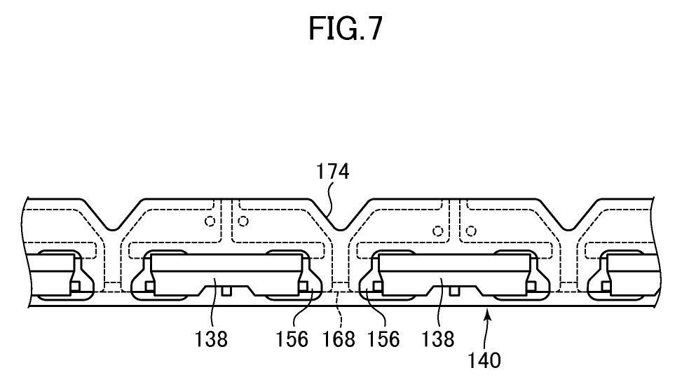

FIG. 7 is a view for explaining a modification 1 of the flexible printed circuit board. A flexible printed circuit board 140 (formed of at least one insulation film) has a cutout portion 174 at a position displaced from a wiring portion 168 in the width direction of a flexible printed circuit board 140. Due to such a constitution, it is possible to reduce a bending resistance of the flexible printed circuit board 140 when the flexible printed circuit board 140 is bent along a line which extends in the width direction while passing the wiring portion 168. Accordingly, the flexible printed circuit board 140 becomes relatively difficult to be bent in a region where a bonding portion 156 is formed.

In other words, the flexible printed circuit board 140 (formed of at least one insulation film) has the cutout portion 174 between light emitting parts 138 arranged adjacent to each other. Due to such a constitution, it is possible to reduce a bending resistance of the flexible printed circuit board 140 when the flexible printed circuit board 140 is bent along a line which extends in the width direction while passing between the light emitting parts 138 arranged adjacent to each other. Accordingly, the flexible printed circuit board 140 becomes relatively difficult to be bent in a region where the light emitting part 138 is mounted.

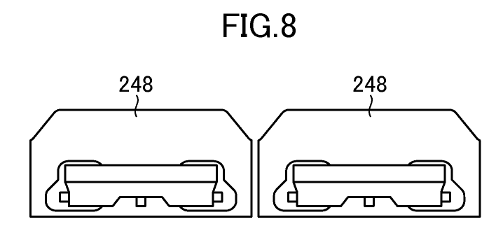

FIG. 8 is a view for explaining a modification 2 of the flexible printed circuit board. In this modification, an insulation film 248 which constitutes an uppermost layer is cut in the width direction of the flexible printed circuit board. Other constitutions of the flexible printed circuit board are substantially equal to the corresponding constitutions of the flexible printed circuit board 140 shown in FIG. 7. That is, in this modification, at least one insulation film other than at least one insulation film having the cutout portion 174 shown in FIG. 7, that is, an insulation film 248 is cut in the width direction.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising:
a liquid crystal display panel;
a plurality of light emitting parts which are arranged in at least one row; and
a flexible printed circuit board on which the plurality of light emitting parts are mounted, the flexible printed circuit board having a length extending in an arrangement direction of the plurality of light emitting parts and a width extending in a direction orthogonal to the length; wherein
each light emitting part includes electrodes on both end portions thereof along the arrangement direction of the plurality of light emitting parts in at least one row,
the flexible printed circuit board includes a wiring pattern which is electrically connected to the electrodes of each light emitting part,
the wiring pattern includes bonding portions where the light emitting part is bonded to the electrodes, and a wiring portion which is continuously formed in a length direction in a first region which includes a region formed between the light emitting parts arranged adjacent to each other and between the bonding portions arranged adjacent to each other, and a region displaced from the region in a width direction,
a fixing region portion of the wiring pattern which is positioned in a second region including a region where the bonding portion of the flexible printed circuit board is formed and a region displaced from the bonding portion in the width direction is larger than the wiring portion in the width direction.

2. The liquid crystal display device according to claim 1, wherein the flexible printed circuit board is a laminated substrate and the wiring pattern is constituted of a plurality of wiring layers,
at least one of the wiring layers includes the fixing region portion,
at least one of the wiring layers includes the wiring portion, and
a total length of the fixing region portion of at least one of the wiring layers in the width direction is larger than a total length of the wiring portion of at least one of the wiring layers in the width direction.

3. The liquid crystal display device according to claim 1, wherein the wiring pattern includes an overlapping portion which overlaps with the each light emitting part, and
the overlapping portion has a larger area than the wiring portion.

4. The liquid crystal display device according to claim 2, wherein the wiring pattern includes an overlapping portion which overlaps with the each light emitting part,
the overlapping portion has a larger area than the wiring portion,
at least one of the wiring layers includes the overlapping portion,
at least one of the wiring layers includes the wiring portion, and
a total area of the overlapping portion of at least one of the wiring layers is larger than a total area of the wiring portion of at least one of the wiring layers.

5. The liquid crystal display device according to claim 1, wherein the electrode of the light emitting part is bonded to the bonding portion by soldering.

6. The liquid crystal display device according to claim 1, wherein the flexible printed circuit board has a cutout portion at a position displaced from the wiring portion in the width direction.

7. The liquid crystal display device according to claim 1, wherein the flexible printed circuit board includes a plurality of insulation films laminated to each other, and
at least one of the insulation films has a cutout portion at a position displaced from the wiring portion in the width direction.

8. The liquid crystal display device according to claim 7, wherein at least one of the insulation films other than the at least one of the insulation films which has the cutout portion is cut in the width direction.
